(19) United States
(12) Patent Application Publication
(10) Pub. No.: US 2012/0269488 A1
(43) Pub. Date: Oct. 25, 2012

(54) METHODS FOR PREPARATION AND DISPOSING OF AN OPTICAL FIBER(S) INTO A BLIND HOLE(S) AND RELATED ASSEMBLIES AND METHODS OF MAKING SAME

(76) Inventors: Jeffrey Dean Danley, Hickory, NC (US); Jeffery Alan DeMeritt, Painted Post, NY (US); Dennis Michael Knecht, Hickory, NC (US); James Phillip Luther, Hickory, NC (US); Darrin Max Miller, Hickory, NC (US); Timothy Frederick Summers, Hickory, NC (US)

(21) Appl. No.: 13/478,644

(22) Filed: May 23, 2012

Related U.S. Application Data
(63) Continuation of application No. PCT/US10/56363, filed on Nov. 11, 2010.
(60) Provisional application No. 61/264,117, filed on Nov. 24, 2009.

(51) Int. Cl. G02B 6/00; G02B 6/25

(52) U.S. Cl. 385/135; 29/825; 29/857

(57) ABSTRACT

Methods for preparation and disposing of an optical fiber(s) into a blind hole(s) and related assemblies and methods of making same are disclosed. In one embodiment, a method for processing an optical fiber(s) is provided. The method includes processing an end portion(s) of the optical fiber(s) with a laser. The end portion(s) of the optical fiber(s) is disposed in a blind hole(s). The blind hole(s) may be disposed in a holding structure. The optical fiber(s) is attached to the holding structure. A fixture is also disclosed and may be used for retaining the optical fiber(s) in a channel(s) disposed in the fixture during preparation and/or disposing of the optical fiber(s) in the blind hole(s). An assembly prepared in accordance with the methods provided herein is also disclosed. In one embodiment, the assembly could include a holding structure assembly for an array of the optical fibers.

### PRIORITY APPLICATION

This application is a continuation of International Application No. PCT/US10/56363 filed Nov. 11, 2010, which claims the benefit of priority to U.S. Application No. 61/264,117, filed Nov. 24, 2009, both applications being incorporated herein by reference.

### BACKGROUND

1. Field of the Disclosure

The field of the disclosure relates to preparation and disposing of an optical fiber and/or optical fiber array(s) into a blind hole(s), and related assemblies and methods of making same.

2. Technical Background

Benefits of optical fiber include extremely wide bandwidth and low noise operation. Because of these advantages, optical fiber is increasingly being used for a variety of applications, including but not limited to broadband voice, video, and data transmission. Fiber optic networks employing optical fiber are being developed and used to deliver voice, video, and data transmissions to subscribers over both private and public networks. These fiber optic networks often include separated connection points linking optical fibers to provide “live fiber” from one connection point to another connection point. In this regard, fiber optic equipment is located in data distribution centers or central offices to support optical fiber interconnections.

Optical fibers can be spliced or connectorized with fiber optic connectors to form optical connections with other optical fibers. Fiber optic connectors allow easy mating and demating of optical fibers. If a fiber optic connector is installed on an optical fiber during manufacture or assembly of fiber optic cable, this is known as a pre-connectorized optical fiber. In any of these cases, it is important that the end faces of optically connected optical fibers be precisely aligned and brought close together to avoid or reduce coupling loss. For example, with fiber optic connectors, the optical fiber is disposed through a ferrule that precisely locates the optical fiber with relation to the fiber optic connector housing. When the fiber optic connector is connected to another fiber optic connector to provide an optical connection, the optical fibers disposed through the respective ferrules in the fiber optic connectors are longitudinally aligned to one another. The geometries of the fiber optic connector provide for efficient light transfer.

Even with precise alignment of optically connected optical fibers, coupling losses can also occur due to other reasons. For example, coupling losses can occur due to the obstruction of light from dust and dirt (generally referred to as “debris”) disposed on or proximately located to the end face of an optical fiber. For example, gels used in fiber optic cables often attract dust and dirt at the point of a splice or the disposition of a fiber optic connector on an optical fiber provided in the fiber optic cable. In this regard, debris insensitive mate and demate applications are being provided to avoid or reduce coupling losses due to debris.

### SUMMARY OF THE DETAILED DESCRIPTION

Embodiments disclosed herein include suitable preparation and disposing of an optical fiber and/or optical fiber arrays into blind holes, and related assemblies and methods of making same. Disposing an optical fiber in a blind hole can be employed to provide debris insensitive connection applications for optical fibers to avoid or reduce coupling loss by reducing or preventing debris from reaching an end face of an optical fiber. In this regard, in one embodiment, a method for processing an optical fiber is provided. The method includes processing an end portion of at least one optical fiber with a laser. A non-planar end face may be disposed on the end portion with the laser. The end portion of the at least one optical fiber is disposed in at least one blind hole disposed in a holding structure. The at least one optical fiber is attached to the holding structure. Other methods are disclosed that can include processing a plurality of optical fibers forming an optical fiber array. A fixture can also be provided for placing the optical fiber into a channel or the plurality of optical fibers into a plurality of channels disposed in the fixture. An assembly prepared in accordance with the methods provided herein could be provided. In one embodiment, the assembly could include a holding structure assembly for an array of the optical fibers. The holding structure assembly may comprise a plurality of optical fibers and a holding structure comprised of a plurality of blind holes with end portions of the plurality of optical fibers processed with a laser disposed therein.

Additional features and advantages will be set forth in the detailed description which follows, and in part will be readily apparent to those skilled in the art from that description or recognized by practicing the same as described herein, including the detailed description that follows, the claims, as well as the appended drawings.

It is to be understood that both the foregoing general description and the following detailed description present embodiments that are intended to provide an overview or framework for understanding the nature and character of the claims. The accompanying drawings are included to provide a further understanding of the disclosure, and are incorporated into and constitute a part of this specification. The drawings illustrate various embodiments and together with the description serve to explain the principles and operation.

### BRIEF DESCRIPTION OF THE FIGURES

FIG. 1 is a perspective view of an exemplary assembly comprised of optical fibers in an optical fiber array disposed into respective blind holes disposed in an exemplary holding structure;

FIG. 2A is a perspective view the optical fiber array in FIG. 1 prior to the end portions of the optical fibers being separated from each other;

FIG. 2B is a perspective view the optical fiber array in FIG. 1 after the end portions of the optical fibers have been separated from each other and “fanned out”;

FIG. 3 is a perspective and side view of an exemplary end portion of an optical fiber having a planar end profile disposed in a blind hole having a non-planar profile;

FIG. 4 is a perspective view of the optical fibers in the optical fiber array in FIG. 1 disposed into channels in a fixture;

FIG. 5A is a perspective view of a cover that can be disposed on the fixture in FIG. 4 to secure the optical fibers in the channels of the fixture;

FIG. 5B is a perspective view of the cover in FIG. 5A disposed on the fixture;

FIG. 6 is a perspective view of outer coatings removed from the optical fibers of the optical fiber array in FIG. 1;

FIG. 7 is a top view of exemplary laser cutting and processing of end portions of the optical fibers extending from the fixture illustrated in FIGS. 5A and 5B to dispose non-planar end faces on the end portions of the optical fibers;

FIG. 8 is a perspective and side view of the end portions of the optical fibers where the end portions have been processed with a laser according to exemplary laser processing embodiments disclosed herein and disposed into blind holes in the holding structure of FIG. 1;

FIG. 9 is a schematic diagram of an exemplary optical fiber and blind hole during exemplary laser processing;

FIG. 10 is an illustration of an exemplary intermitting sinusoidal signal that controls a path of an exemplary laser during optical fiber processing;

FIG. 11 is a schematic diagram illustrating an optical fiber position relative to an exemplary laser path;

FIG. 12 a schematic diagram illustrating an exemplary orientation of an exemplary laser in relation to a processed optical fiber;

FIG. 13 is a diagram showing the angle of the end face of an exemplary laser-shaped optical fiber relative to a plane perpendicular to a longitudinal axis of the optical fiber;

FIGS. 14 and 15 schematically represent an enlarged view of an exemplary optical fiber being laser-shaped and the exemplary laser-shaped optical fiber, respectively;

FIG. 16 is an image of an optical fiber being laser-shaped as described herein;

FIG. 17 is an image of an exemplary laser-shaped optical fiber end face of FIG. 16 taken under magnification;

FIGS. 18 and 19 schematically represent an enlarged view of an optical fiber being laser-shaped and the laser-shaped optical fiber, respectively, in accordance with another embodiment;

FIG. 20 is a side view of exemplary laser cutting and processing of end portions of optical fibers having a polymer cladding, which may be disposed in and extend from the fixture illustrated in FIGS. 5A and 5B, to dispose non-planar end faces on the end portions of the optical fibers;

FIG. 21 is a side view of the end portion of the optical fiber of FIG. 20 after being cut and processed by the laser in FIG. 20;

FIG. 22 is a perspective view of the optical fibers extending from the fixture illustrated in FIGS. 5A and 5B illustrating the non-planar end faces disposed on the end portions of the optical fibers after the end portions have been processed with a laser according to exemplary laser processing embodiments disclosed herein;

FIG. 23A is a perspective view of a holding structure having blind holes disposed therein prior to disposing of the end portions of the optical fibers having non-planar end faces in FIG. 8 into the blind holes;

FIG. 23B is a perspective view of the end portions of the optical fibers of FIG. 23A disposed in the blind holes of the holding structure in FIG. 23A and the optical fibers attached to the holding structure;

FIG. 24 is a perspective view of an alternative arrangement of optical fibers having non-planar end faces disposed in blind holes of a holding structure and attached to the holding structure;

FIG. 25 is a perspective view of the cover in FIGS. 23A and 23B removed from the fixture after the end portions of the optical fibers have been disposed in the blind holes of the holding structure and the optical fibers attached to the holding structure;

FIG. 26A is a perspective view of a top portion of a fiber optic housing configured to receive the fixture retaining the optical fibers attached to the holding structure of FIG. 25;

FIG. 26B is a perspective view the fixture retaining the optical fibers attached to the holding structure of FIG. 25 disposed in the top portion of the fiber optic housing of FIG. 26A;

FIG. 27 is a perspective view of optical fibers disposed in the holding structure of FIG. 26A after being displaced from the fixture disposed in the top portion of the fiber optic housing in FIG. 26B;

FIG. 28A is a perspective view of a bottom portion of a fiber optic housing configured to attach to the top portion of the fiber optic housing of FIGS. 26A and 26B; and

FIG. 28B is a perspective view of the top and bottom portions of the fiber optic housing of FIG. 28A attached to each other with the optical fibers disposed in the holding structure of FIG. 25 disposed therein to form a fiber optic connector.

### DETAILED DESCRIPTION

Reference will now be made in detail to the certain embodiments of the present disclosure, examples of which are illustrated in the accompanying drawings, in which some, but not all embodiments are shown. Indeed, the concepts may be embodied in many different forms and should not be construed as limited to the embodiments set forth herein; rather, these embodiments are provided so that this disclosure will satisfy applicable legal requirements. The embodiments and methods described herein are suitable for making optical connections for short distance optical networks. The concepts of the disclosure advantageously allow the simple, quick, and economical connection and disconnection of optical fibers. Reference will now be made in detail to the preferred embodiments, examples of which are illustrated in the accompanying drawings. Whenever possible, like reference numbers will be used to refer to like components or parts.

Embodiments disclosed herein include suitable preparation and disposing of an optical fiber and/or optical fiber arrays into blind holes, and related assemblies and methods of making same. Disposing an optical fiber in a blind hole can be employed to provide debris insensitive connection applications for optical fibers to avoid or reduce coupling loss by reducing or preventing debris from reaching an end face of an optical fiber. In this regard, in one embodiment, a method for processing an optical fiber is provided. The method includes processing an end portion of at least one optical fiber with a laser. A non-planar end face may be disposed on the end portion with the laser. The end portion of the at least one optical fiber is disposed in at least one blind hole disposed in a holding structure. The at least one optical fiber is attached to the holding structure. Other methods are disclosed that can include processing a plurality of optical fibers forming an optical fiber array. A fixture can also be provided for placing the optical fiber into a channel or the plurality of optical fibers into a plurality of channels disposed in the fixture. An assembly prepared in accordance with the methods provided herein could be provided. In one embodiment, the assembly could include a holding structure assembly for an array of the optical fibers. The holding structure assembly may comprise a plurality of optical fibers and a holding structure comprised of a plurality of blind holes with end portions of the plurality of optical fibers processed with a laser disposed therein.

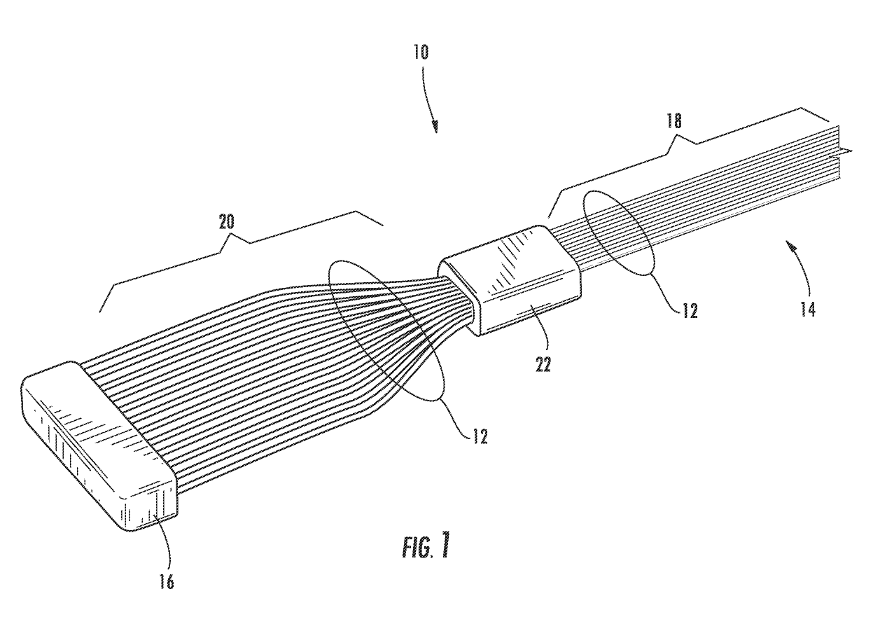

In this regard, FIG. 1 is a perspective view of an exemplary assembly 10 that may be employed in accordance with one embodiment disclosed herein. The assembly 10 may provide a debris insensitive application for mating and demating of optical fibers. In this embodiment, the assembly 10 is comprised of exemplary optical fibers 12 in an optical fiber array 14 disposed into respective blind holes (element 15 in FIG. 3) in a holding structure 16. As will be illustrated and discussed in more detail below, a blind hole is a hole into which there is only one entry and exit point and may be formed by any suitable manner. The holding structure 16 may be considered to be a ferrule type structure for example. The holding structure 16 in this embodiment is formed from a polymer, but could be formed from any other material desired. The holding structure 16 may also be partially or completely translucent. Additionally, the holding structure may be formed from more than one piece instead of being a monolithic structure. For instance, the holding structure may have a two-piece construction such as a body and an end cap that attaches onto an end of the body (part-line not visible), thereby forming blind holes. If the holding structure includes the endcap, the endcap may be removed as desired for processing, assembly, or the like. Still other embodiments of the holding structure can use more than two pieces such as forming the blind hole by inserting a respective component into respective through bores of the holding structure, thereby forming respective blind holes. Disposing the optical fibers 12 in blind holes 15 (FIG. 3) may provide a debris insensitive optical fiber mate and demate application or applications. As will be discussed in more detail below, the optical fibers 12 can be disposed in the blind holes 15 such that debris is prevented from further entering into the blind holes 15 and attaching or surrounding the end faces (not shown) of the optical fibers 12. Debris attached to or surrounding end faces of optical fibers can result in coupling loss by obstructing transfer of light.

With continuing reference to FIG. 1, the optical fiber array 14 in this embodiment is comprised of twelve (12) optical fibers 12. However, any number of the optical fibers 12 could be provided in the optical fiber array 14, including, without limitation, one (1), two (2), four (4), eight (8), twenty-four (24) or any other suitable number of optical fibers. In this embodiment, the optical fiber array 14 may be provided as part of a fiber optic ribbon and/or ribbon cable whereby the optical fibers 12 are bonded together in a first section 18 and separated at end portions 20 of the optical fiber 12. In this manner, the end portions 20 of the optical fibers 12 can be disposed in blind holes in the holding structure 16. A retaining structure 22 may be disposed over the end portions 20 of the optical fibers 12 prior to being disposed in the blind holes 15 of the holding structure 16 to register the optical fiber array 14 in a fixture to be discussed in more detail below and/or to prevent the optical fibers 12 in the first section 18 from separating or to provide strain relief. For example, as will be discussed in further detail below, the end portions 20 of the optical fibers 12 are involved in processes that include forces being applied to the end portions 20, such as during disposition into the holding structure 16 as an example. It may be desired to provide the retaining structure 22 to minimize the translation of these forces to the optical fibers 12 in the first section 18.

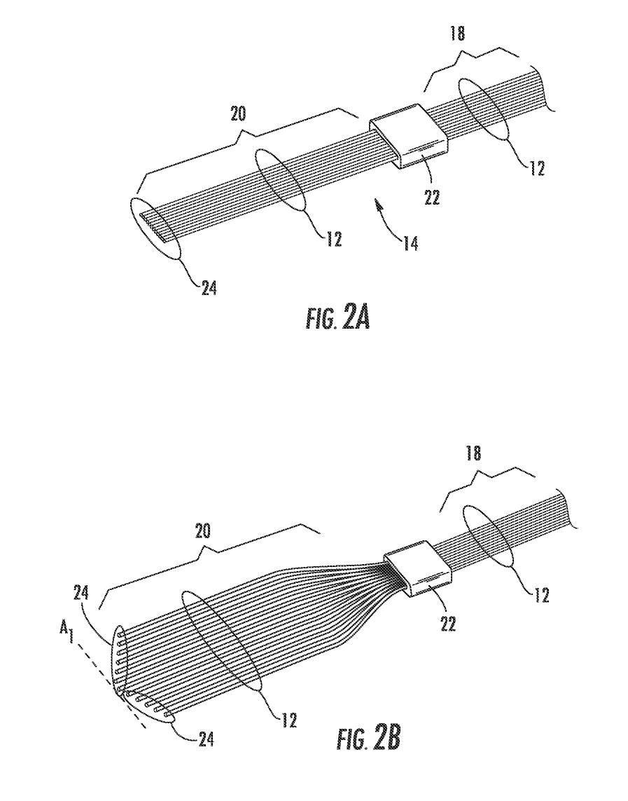

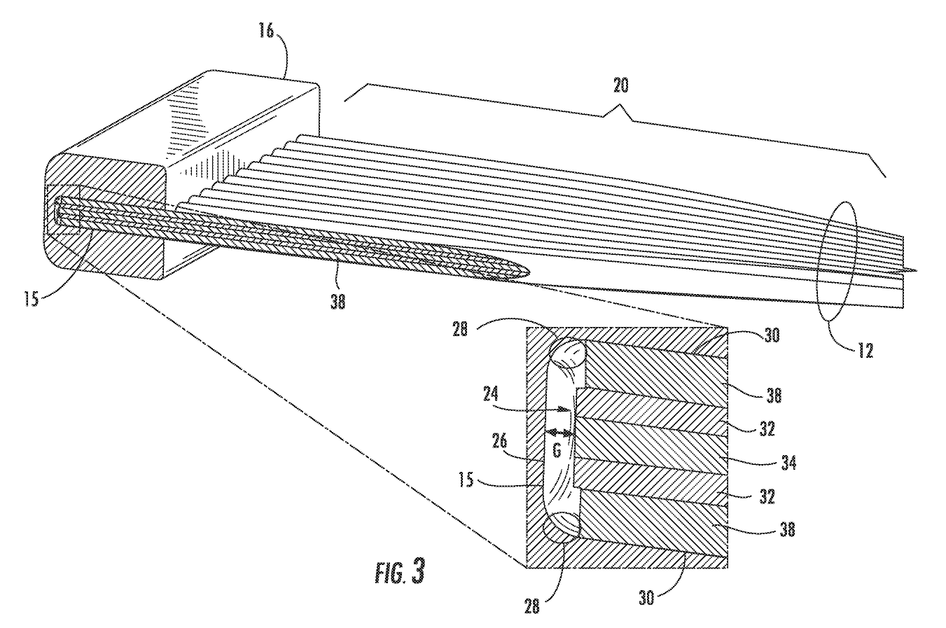

To provide the assembly 10 in FIG. 1, various methods can be employed. Examples of exemplary methods in this regard are described in this disclosure. The remainder of this application discusses exemplary methods of producing the assembly 10 of FIG. 1 and other exemplary assemblies and methods of making same. In this regard, FIG. 2A illustrates the optical fiber array 14 in FIG. 1 before the end portions 20 of the optical fibers 12 are separated from each other, or “fanned out,” to prepare the end portions 20 to be disposed in the holding structure 16. End faces 24 of the end portions 20 of the optical fibers 12 are aligned with end faces 24 of other end portions 20 to provide optical connections are shown in FIG. 2A. These end faces 24 will eventually be disposed in the blind holes 15 (FIG. 3) disposed in the holding structure 16 of FIG. 3, as described in greater detail below.

As illustrated in FIG. 1 and discussed above, the end portions 20 of the optical fibers 12 are separated before being disposed in the holding structure 16 in this embodiment. In this regard, as illustrated in FIG. 2B, the end portions 20 are separated and fanned out so that the end portions 20 can be disposed in respective blind holes 15 (FIG. 3) disposed in the holding structure 16. However, as shown in FIG. 2B, when the end portions 20 are fanned out, the end faces 24 will not be co-planar, meaning that the end faces 24 are not aligned along the same axis A₁. As a result, different gap lengths G will exist between the end faces 24 of the optical fibers 12 and bottom surfaces or seats 26 of the blind holes 15 when disposed therein, as illustrated in FIG. 3, because the seats 26 are co-planar. Different gap lengths G between the end faces 24 of different end portions 20 of the optical fibers 12 disposed in the holding structure 16 can cause variations in coupling losses between the optical fibers 12. The greater the gap length G, typically the greater the coupling loss. Further, because non-co-planarity between end faces 24 of the end portions 20 of the optical fibers 12 disposed in the blind holes 15 results in only the end faces 24 of the longest length end portions 20 bottoming against the seats 26 of the blind holes 15 (i.e., gap length G approximately equal to zero (0)), coupling losses can occur due to all end faces 24 not being located at or near the seat 26. Thus, as will be discussed in more detail below, methods and assemblies disclosed herein can be employed to provide co-planarity between end faces of the optical fibers in an optical fiber array, including between end faces 24 of the end portions 20 of the optical fibers 12 in the optical fiber array 14.

Other factors can result in the end faces 24 of the end portions 20 not being bottomed against the seat 26 of the blind hole 15, thereby resulting in coupling losses. For example, as illustrated in FIG. 3, the seat 26 of the blind hole 15 may be curved or have rounded edges 28. The rounded edges 28 of the blind hole 15 may result from wear of a tool or mould used to form the blind holes 15 in holding structures 16 during manufacture due to repeated use of the tool or mould over time. Thus, as illustrated in FIG. 3, when a planar end face 24 of the end portion 20 of the optical fiber 12 is disposed in the blind hole 15, the end face 24 will not reach the seat 26. An outer coating 38 disposed around a cladding 32, which is disposed around a core 34, of the end portions 20 and down from the end face 24 can interfere with the rounded edges 28 of the blind hole 15 before the end face 24 can reach the seat 26 of the blind hole 15 thereby causing the gap length G to exist between the end face 24 and the seat 26, as illustrated in FIG. 3. Thus, as will be discussed in more detail below, methods and assemblies disclosed herein can be employed to provide non-planar end faces on the end portions 20 of the optical fibers 12, as opposed to a planar end face 24 as illustrated in FIG. 3, to allow the end faces to bottom against the seat 26 of the blind hole 15 or to reduce the gap length G between the end face and the seat 26. For example, the end faces of the optical fibers 12 may be prepared to have a non-planar shape and/or a shape that is the same or similar to the shape of the seat 26 of the blind hole 15.

As further illustrated in FIG. 3, the optical fiber 12 may include either a glass or polymer outer coating 38 surrounding the cladding 32, to provide, for example, an all glass optical fiber, or a plastic clad silica optical fiber, but other suitable optical fiber constructions are possible. Alternatively, the cladding 32 may be formed from a polymer, such as provided in plastic clad silica. In any of these cases, if the end face 24 of the optical fiber 12 is planar, as illustrated in FIG. 3, the end faces 24 of the optical fiber 12 can skive or scrape the blind hole 15 when disposed (i.e., inserting the optical fibers) in the blind hole 15 thus possibly removing the outer coating 38 and damaging the cladding 32 and possibly the core 34 which would result in coupling loss. Thus, as will be discussed in more detail below, methods and assemblies disclosed herein can be employed to eliminate or reduce skiving by the optical fibers 12 when disposed in the blind holes 15 of the holding structure 16.

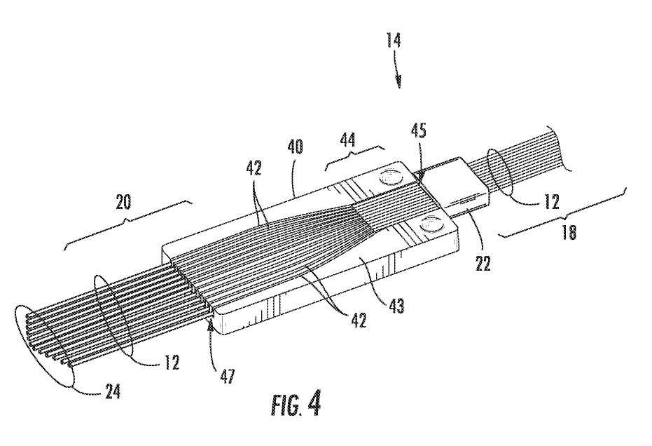

In an exemplary embodiment, one aspect of the methods and assemblies disclosed herein involve preparing the end portions 20 of the optical fibers 12 so that the end faces 24 are co-planar or have co-planarity. The benefits of co-planarity were previously described above. FIG. 4 illustrates one step that can be employed in this regard. As illustrated in FIG. 4, a fixture 40 is provided. The fixture 40 is a device that is separate from the assembly 10 in FIG. 1 and from the optical fibers 12. The fixture 40 provides a plurality of channels 42 disposed in a surface 43 that are each configured to receive and secure individual optical fibers 12 from the optical fiber array 14 to assist in preparing end faces 24 of the optical fibers 12 to have co-planarity. As illustrated in FIG. 4, the first sections 18 of the optical fibers 12 are disposed in a common section 44 in the fixture 40 that does not require separation of the individual optical fibers 12. The first sections 18 exit the fixture 40 and channels 42 on an inlet side 45 of the fixture 40. The common section 44 disposed in the fixture 40 then splits into the individual channels 42 each configured to receive an individual end portions 20 of an optical fiber 12.

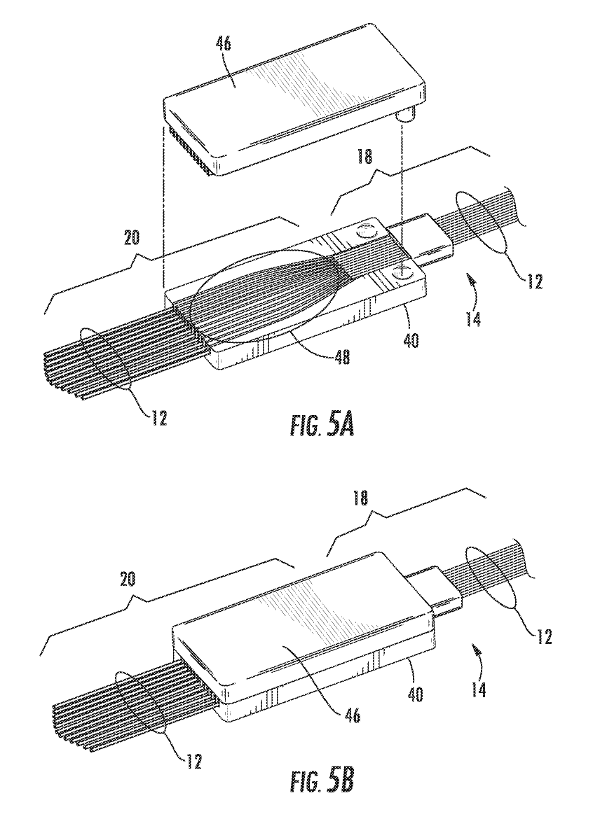

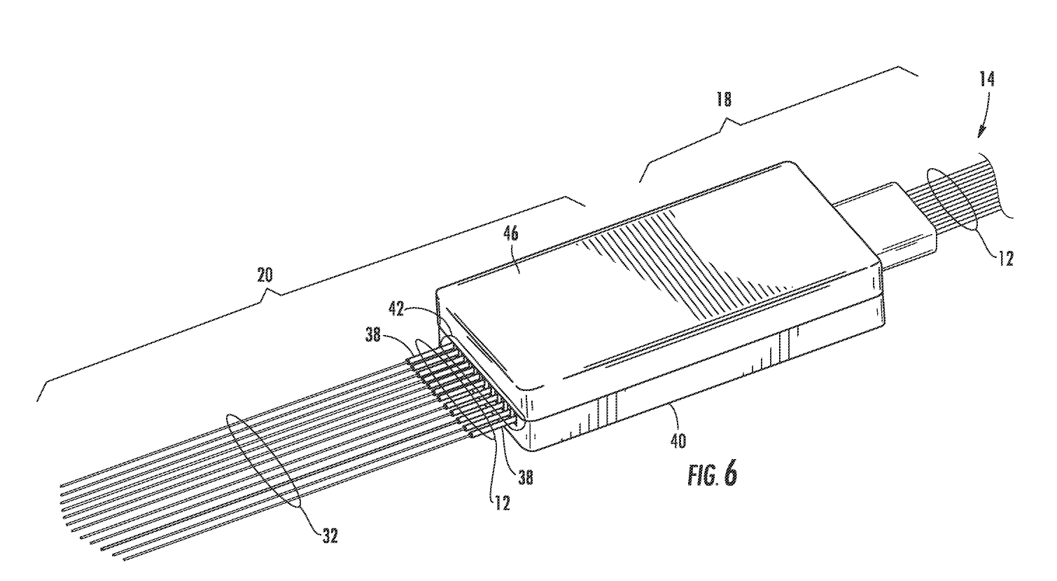

The fixture 40 illustrated in FIG. 4 illustrates each of the twelve (12) end portions 20 of the optical fibers 12 disposed in channels 42. The channels 42 form a fan-out pattern 48 (FIG. 5A) that is to be provided in the assembly 10, as illustrated in FIG. 1, when the end portions 20 exit from the channels 42 on an outlet side 47 of the fixture 40. To secure the end portions 18 of the optical fibers 12 for preparation of the end faces 24, a cover 46, as illustrated in FIG. 5A, is disposed on the fixture 40, as illustrated in FIG. 5B, to secure the end portions 20 of the optical fibers 12 in the channels 42. For example, as discussed in more detail below, the fixture 40 may be rotated or flipped during processing of the end portions 20 when the optical fibers 12 are retained in the channels 42. The cover 46 can secure the optical fibers 12 during this processing. For example, the optical fiber 12 may be disposed in the channels 42 of the fixture 40 such that between 0.5 and 1.0 millimeters (mm) of length of the end portions 20 are extended from the outlet side 47 of the fixture 40, although these lengths are not required and are not limiting. The retaining structure 22 may be disposed on the optical fiber array 14 to provide for the end portions 20 to be extended from the outlet side 47 of the fixture 40 at the desired length.

Next, the outer coating 38 is removed from a portion of the end portions 20 of the optical fibers 12 while the optical fibers 12 are secured in the fixture 40, as illustrated by example in FIG. 6. The claddings 32 and cores 34 of the end portions 20 are exposed as a result, as also illustrated in FIG. 6. Removing portions of the outer coatings 38 allows the core 34 and cladding 32 to be exposed on an end face to allow preparation of a non-planar end faces on the end portions 20, as will be discussed in more detail below.

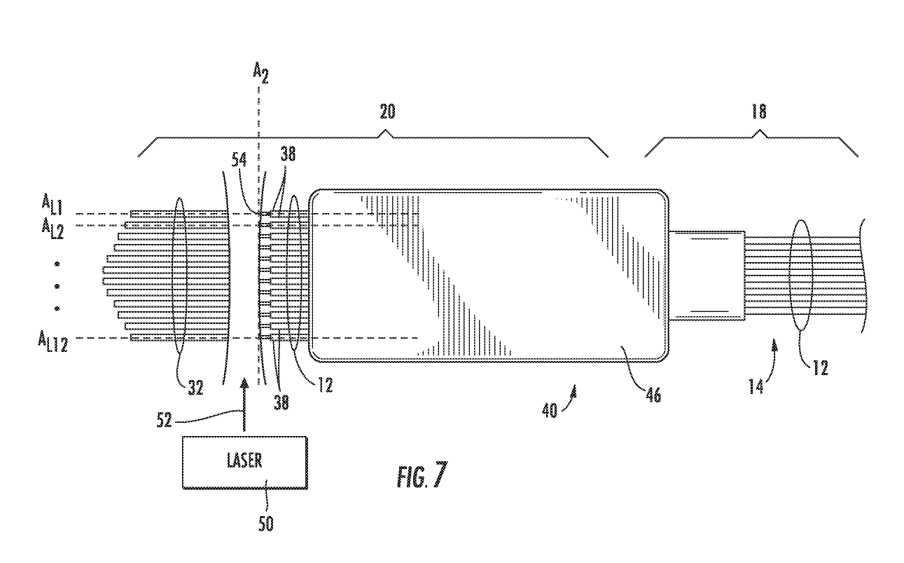

Next, the exemplary process involves cutting the end portions 20 of the optical fibers 12 where the outer coating 38 has been removed, as illustrated in FIG. 6, and preparing end faces on the end portions 20 of the optical fibers 12 that are co-planar with each other or have non-co-planarity. Because the end portions 20 extending from the fixture 40 are disposed in the channels 42 in the “fan-out” pattern 48 (as shown in FIG. 5A), a laser 50 can be employed to direct a laser beam 52 across axis A₂ orthogonal to longitudinal axes A_{L1}-A_{L12} of the end portions 20 of the optical fibers 12 exposed from the fixture 40 to cut the end portions 20 and prepare end faces 54 having co-planarity, as illustrated in FIG. 7. Although FIG. 7 illustrates the laser 50 directing the laser beam 52 across multiple end portions 20, it is to be understood that the laser 50 and laser beam 52 are not necessarily oriented in the orientation provided in FIG. 7. For example, each end portion 20 may need to be specifically oriented to the laser beam 52, or vice versa, to bring the end portion 20 to be laser-processed into the correct focus of the laser beam 52 for the desired processing and preparation of the end face 54. The benefits of co-planarity of end faces of the optical fiber 12 have been previously discussed. Alternatively, the end portions 20 could be mechanically cleaved to be cut, instead of being cut by a laser, and to expose the claddings 32 and cores 34, wherein laser processing or laser cleaving is then employed to prepare the end faces 54. The result of laser processing or laser cleaving to prepare the end faces 54 of the end portions 20 can also leave a polished or polish like finish on the end faces 54 such that further polishing or preparation of the end face 54 is not required after laser processing.

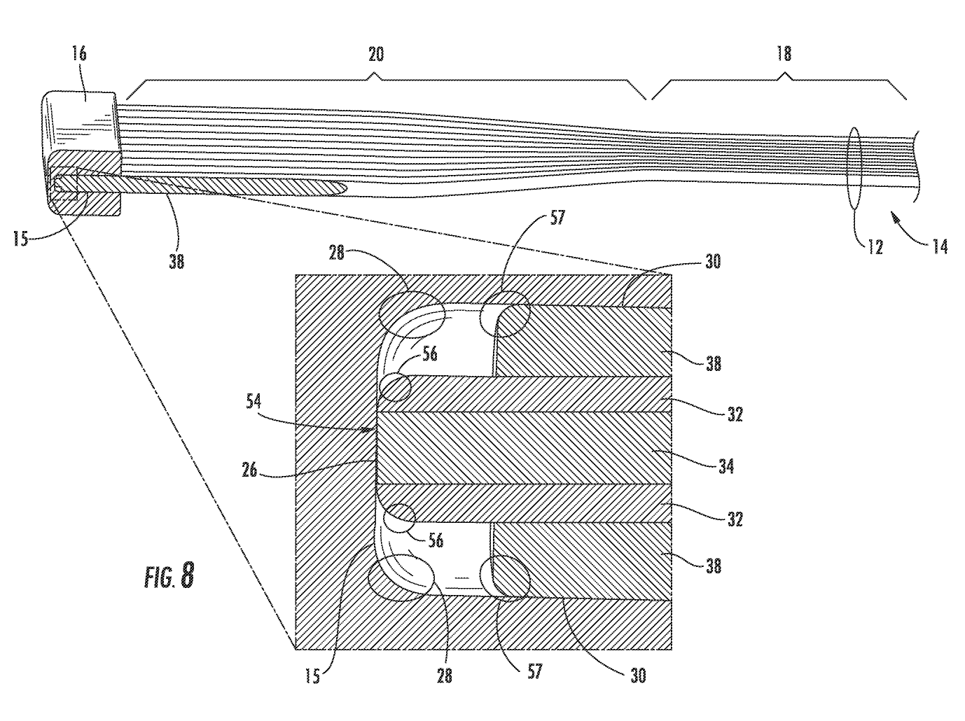

In either scenario of laser cutting or mechanical cleaving of the end portions 20, laser processing is employed in this embodiment to prepare the non-planar end faces 54. This is illustrated by example in FIG. 8. As illustrated therein, the end portion 20 of the optical fiber 12 contains an end face 54 that is non-planar. The end face 54 contains a rounded edge 56 around the circumferential area of the cladding 32 in this embodiment as a result of laser processing. Thus, when the end portion 20 is disposed in the blind hole 15, the non-planar end face 54 bottoms against the seat 26 of the blind hole 15. As previously discussed, providing non-planar end faces on the end portions 20 of the optical fibers 12 can eliminate or reduce the gap length G (FIG. 3) between the end faces 54 and the seats 26 of the blind holes 15 to avoid or reduce coupling loss. The laser processing may also provide a rounded edge 57 around the circumferential area of the outer coating 38 in this embodiment to provide a non-planar profile. Providing a non-planar profile on the outer coating 38 disposed adjacent the end face 54 of the end portion 20 can assist in preventing stubbing or skiving by the outer coating 38, the cladding 32, and/or the core 34 of the end portion 20 of the optical fiber 12 when inserted and disposed in the blind hole 15. Additionally, the non-planar profile on the outer coating may provide a reservoir for bubbles and/or debris when inserted and disposed in the blind hole.

Further, providing a non-planar end face 54 on the end portion 20 can also leave additional room in the blind hole 15 for excess adhesive or epoxy disposed in the blind hole 15 and/or for trapped gas or air or bubbles due to insertion of the end portion 20 into the blind hole 15, as discussed in more detail below. Note that even if the end face 54 were planar, the laser processing provided by the laser 50, as described in more detail below, also has the benefit of drawing back the cladding 34 (if a polymer) from the end face 54, as illustrated in FIG. 8 due to the heat produced by the laser 50 during the cutting and preparation of the end face 54. This allows the end portion 20 to be inserted into the blind hole 15 such that the end face 54 can more easily bottom against the seat 26, if the cladding 32 being disposed all the way down to the end face 54 would interfere with the rounded edges 28 of the seat 26 of the blind hole 15, as illustrated in FIG. 3.

Details regarding how the laser 50 can be employed to cut the end portions 20 of the optical fibers 12 to achieve co-planarity of the end faces 54, to prepare the end faces 54 to be non-planar, and/or to draw back the cladding 32 are described in more detail below with regard to FIGS. 9-21.

The end portions 20 of the optical fibers 12 are secured by the fixture 40 at this point for further processing and preparations. One processing step that may be performed is to cut and prepare the end faces 54 of the end portions 20 to prepare the end portions 20 to be disposed in the blind holes 15 of the holding structure 16. In this regard, the end portions 20 of the optical fibers 12 may be processed and end faces 54 prepared in accordance with the laser processing embodiments and methods described in U.S. Pat. No. 7,216,512 B2 filed on Oct. 31, 2003, and U.S. patent application Ser. No. 12/474,923 filed on May 29, 2009, entitled “LASER-SHAPED OPTICAL FIBERS ALONG WITH OPTICAL ASSEMBLIES AND METHODS THEREFOR,” both of which are incorporated herein by reference in their entireties. As discussed in more detail below, the end portions 20 of the optical fibers 12 could be processed while the fixture 40 and end portions 20 are stationary or while the fixture 40 and end portions 20 are rotating with respect to a laser beam directed toward the end portions 20. Also, the laser could remain stationary while the laser is pulsed. Further, the fixture 40 can be flipped during laser processing to in turn change the orientation of the end portions 20 relative to a laser beam.

For example, referring to FIG. 9, a schematic diagram of a rotating assembly 60 is shown. The rotating assembly 60 includes the fixture 40 with one or more optical fibers 12 disposed therein as previously described above. To provide for rotation of the fixture 40 and thus the end portion(s) 20 of the optical fiber 12 about its longitudinal axis, the end portion 20 is held in place between a stationary fixture holder 62 and a suitable rotating mechanism 64, such as a servo driven wheel for example. The stationary fixture holder 62 is representative of any known means operable for maintaining the position of the fixture 40 during rotation. The rotating mechanism 64 is representative of any known means operable for rotating an end portion 20 of an optical fiber 12 about its longitudinal axis. The stationary fixture holder 62 should provide support without undue friction. By way of example, the end portion 20 of the optical fiber 12 may be rotated at any suitable rate of rotation such as about two (2) Hertz (Hz) during the first step of the process, but other rotational speeds are possible. The rotation of the fiber/ferrule assembly is essentially stopped for the second step. A tip 65 of the end portion 20 is supported by a second stationary holder 68 comprising a V-groove to minimize the effects of run-out. The amount of end portion 20 protruding beyond the second stationary holder 68 should be sufficiently long to permit cutting and shaping the end face 54 of the end portion 20 using a laser, such as the laser 50 in FIG. 7 for example, and not long enough to result in a possible eccentricity of rotation of the end face 54 being shaped during the first step. Although the terms “first step” and “second step” are used, other steps can occur before, during, between, or after the first and second steps described herein. For instance, the laser may be indexed relative to the optical fiber during processing to shape the optical fiber with a profile or end face more like a “pencil-tip.”

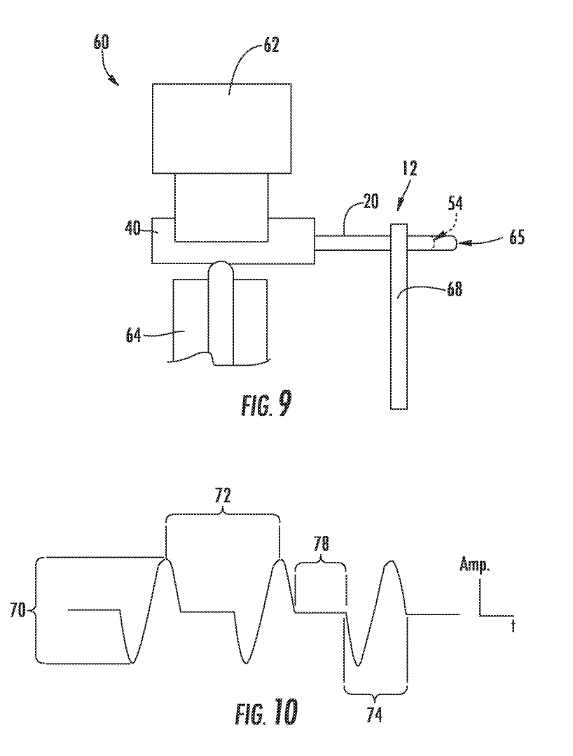

In an exemplary method of laser processing of the end portion 20 of the optical fiber 12, a laser beam 52 (FIG. 7) is swept back and forth across the surface while the end portion 20 is rotating. The energy from a commercially available carbon dioxide (CO₂) laser, such as a one hundred fifty (150) watt maximum sealed tube CO₂ laser available from SYNRAD Inc. of Mukilteo, Wash., can be focused to a spot of about a two hundred (200) micrometer (μm) diameter. In one embodiment, the laser 50 may be focused to a spot slightly larger than the diameter of the end portion 20. The laser 50 may be operated at a frequency of about twenty (20) kilohertz (kHz) and at a fifty percent (50%) duty cycle, as an example. Other operating frequencies and duty cycles are possible. Other exemplary operating frequencies, include but are not limited to five (5) and ten (10) kHz. Referring to FIG. 10, the oscillating motion of the laser 50 may be driven by an intermittent sinusoidal signal that controls the path of the laser during processing. However, note that other signal wave patterns are also possible, such as triangle and saw-tooth waveforms as examples. Turning back to this example, the frequency of the intermittent sinusoidal signal may be about twenty-four (24) Hz, while the burst frequency may be about twelve (12) Hz. The peak-to-peak amplitude of the sinusoidal signal is illustrated by reference numeral 70 (also referred to herein as “sweep path 70”). The period of the burst frequency (i.e., the time required to complete one full cycle of the laser processing) is illustrated by reference numeral 72. The period of the sinusoidal signal frequency that controls the sweep of the laser 50 (i.e., the time required to complete one full cycle of the laser sweep) is illustrated by reference numeral 74. The period of the dwell frequency (i.e., the time between successive laser sweeps) is illustrated by reference numeral 78. The period of the dwell frequency is also equal to the period of the burst frequency minus the period of the sinusoidal signal frequency.

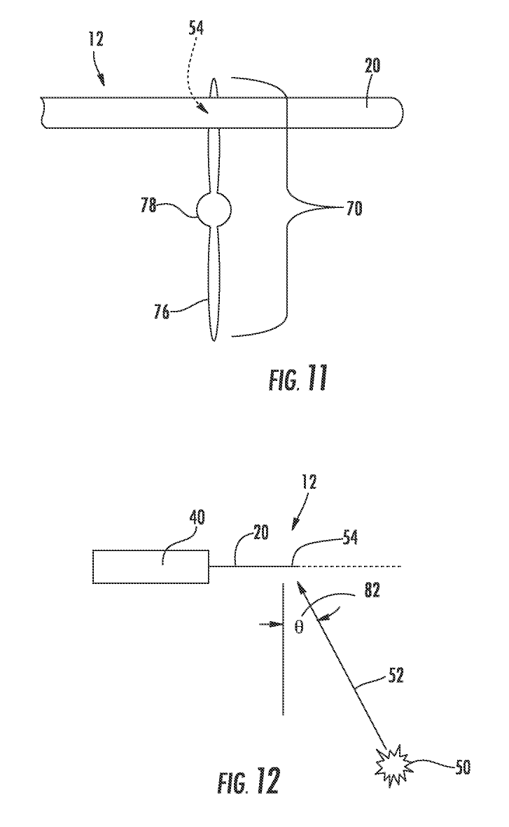

FIG. 11 is a schematic diagram illustrating the position of the end portion 20 of the optical fiber 12 relative to the sweep path 70 of the laser 50. In one embodiment, the end portion 20 may be located from about two (2) to about two and one-half (2.5) fiber widths downward from the uppermost peak of the sinusoidal laser path, and about eight (8) to about ten (10) fiber widths upward from the null, or dwell, position 78 of the laser 50. This positioning produces two deposits of energy onto the end portion 20 of the optical fiber 12 followed by a cooling period before the next deposits of energy are applied. The burn mark of the laser is illustrated by reference numeral 76. The peak-to-peak amplitude of the laser sweep is also illustrated by reference numeral 70 in FIG. 11.

The laser-shaping of the end face 54 of the end portion 20 of the optical fiber 12 disclosed herein is achieved using at least a two-step process. The first step shapes the end face 54 of the end portion 20 while it is rotating. The second step shapes the end face 54 of the end portion 20 after the rotation essentially stops. As used herein, “essentially stopping” or “essentially stopped” means that the rotation of the end portion 20 is stopped or slowed to such as small rotational velocity that the laser beam 52 can be swept through the end portion 20 to create an end surface at the core 34 of the optical fiber 12 (FIG. 8). For instance, both steps impinge an amount of the predetermined laser intensity, in the form of a Gaussian intensity distribution, onto the end portion 20 to be shaped. Upon contact with the end portion 20 of the optical fiber 12, the radiation of the CO₂ laser 50 is absorbed at the surface of the end portion 20. The glass at the surface is raised above its vaporization temperature and is ablated away while heat is conducted into the material of the optical fiber 12. The longer the time the laser 50 is maintained at the surface, the greater the depth of penetration of heat. Therefore, intense short pulses may be used to cause ablation of the surface cladding with minimal melting of the underlying material. The pulse duration and energy intensity of the laser beam 52 are predetermined and adjusted so that the optical fiber 12 material is progressively ablated without re-depositing the ablated material or distorting the remaining optical fiber geometry. The fiber processing method permits precise shaping of the end face 54 of the end portion 20 of the optical fiber 12. The laser 50 is swept in an oscillating motion across the end portion 20 to achieve ablation of the optical fiber 12 and preferably minimizes overheating from energy in the non-ablative region. A convex, or dome shaped, end face 54 with excellent symmetry is achieved by rotating the end portion 20 while pulsing the laser 50. In the case of a stationary end portion 20, a dome shaped end face 54 with elongated symmetry may result. In either case, the end face 54 of the end portion 20 optimally comprises a dome shaped end face 54 with a slightly protruding optical fiber core 34. Additionally, shaping the end portion 20 with the laser 50 while rotating the same also inhibits sag deformation near the outer surface of the optical fiber 12 due to gravity or the like.

FIG. 12 is a schematic diagram illustrating an exemplary orientation of the laser 50 in relation to the end portion 20 of the optical fiber 12. The laser beam 52 from the laser 50 may be directed in the direction of the end portion 20 at a desired angle θ (i.e., 82) from about ten (10) degrees to about sixty (60) degrees from perpendicular to the longitudinal axis of the end portion 20 so that the laser beam 52 impinges the desired end face 54 of the end portion 20. In a preferred embodiment, the angle 82 may range from about fifteen (15) degrees to about forty-five (45) degrees from perpendicular to the longitudinal axis of the end portion 20. In another embodiment, the angle 82 may range from about twenty-five (25) degrees to about thirty-five (35) degrees from perpendicular to the longitudinal axis of the end portion 20. The angle 82 is desired to overcome the approximate Gaussian energy distribution across the diameter of the laser beam 52. The angle 82 may be adjusted to produce a slightly dome shaped end face 54 of the end portion 20 having a protrusion of the core 34 of about two (2) μm to about three (3) μm. Due to heating and ablation effects, the end face 54 of the end portion 20 may have about a five (5) μm to about ten (10) μm radius, which aids insertion of the end portion 20 into the alignment feature (i.e., a composite V-groove) of the mechanical splice assembly. By producing an end portion 20 having a dome shaped end face 54, the optical fiber core 34 leads the cladding 32 of the end portion 20 (FIG. 8). The protruding optical fiber core 34 decreases the gap length G when the end portion 20 is disposed in the blind hole 15 in the holding assembly 16, as illustrated in FIG. 8.

As shown in FIG. 13, the laser-shaped end portion 20 has an angled end face 54 formed at an angle α. The angle α of the end face 54 of the end portion 20 is between zero (0) degrees and ten (10) degrees relative to a plane PP perpendicular to a longitudinal axis LA of the optical fiber 12. More specifically, the non-planar end face 54 of the optical fiber 12 is measured as the angle between the tangent line of a domed surface at the core 34 of the optical fiber 12 and a plane PP perpendicular to the longitudinal axis LA of the optical fiber 12. In preferred embodiments, the angled end face is between four (4) degrees and eight (8) degrees, but other suitable angles are also possible with the concepts disclosed. The end face 54 of the end portion 20 will have a domed surface with the edges of the optical fiber 12 also being curved (i.e., rounded) so that the sharp edges are inhibited.

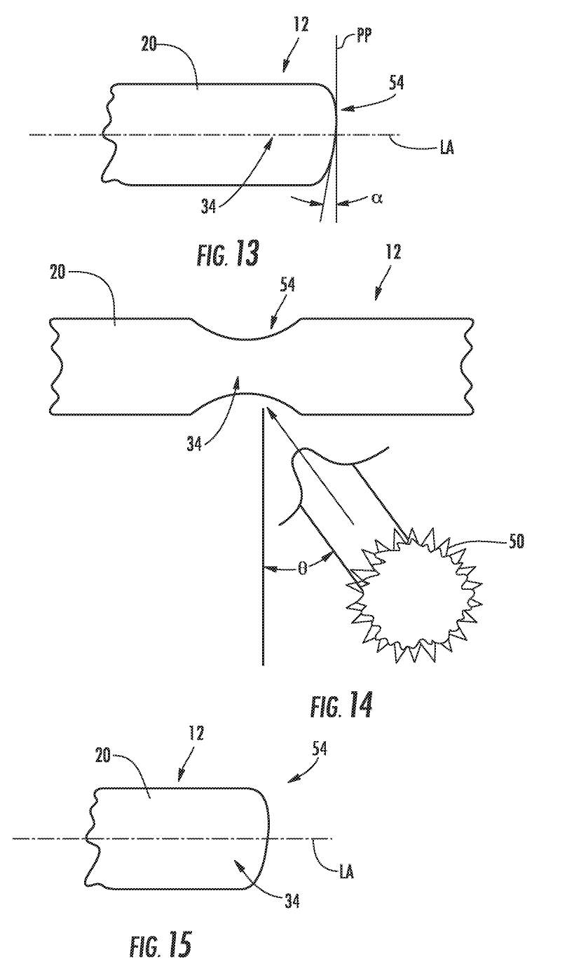

FIGS. 14 and 15 schematically represent an enlarged view of the end portion 20 being laser-shaped in accordance with an exemplary embodiment. The first step of the process “necks” the end portion 20 down by ablating a portion of the end portion 20 while it is being rotated as shown in FIG. 11. The rotational ablation of the end portion 20 can continue for any suitable depth and even into the core 34, but does not cut or sever the optical fiber 12. Before the end portion 20 is cut through or severed, the laser ablation and the rotational motion of the end portion 20 are essentially stopped. As shown by FIG. 14, a portion of the end portion 20 exhibits an hour glass shape from the ablation during the rotational motion of the first process step. Optionally, the hour glass shape of the end portion 20 can be elongated by applying a tensile force to the optical fiber 12 during processing.

The second process step resumes the laser ablation when the end portion 20 is essentially stopped and severs the end portion 20 at the predetermined angle α relative to a plane that is perpendicular to a longitudinal axis of the optical fiber 12. FIG. 15 schematically depicts the end portion 20 after being severed or cut through. The location of the non-planar end face 54 cut generally coincides with a portion of the “necked” region of the end portion 20 produced by the first process step. In certain embodiments, the rotational motion of the end portion 20 is stopped so that it is stationary, thereby creating a high-quality non-planar end face 54. The end portion 20 processed by the method disclosed preferably has a taper or large edge radius that allows the gap length G to be reduced when the end portion 20 is disposed in a blind hole 15, as illustrated in FIG. 8.

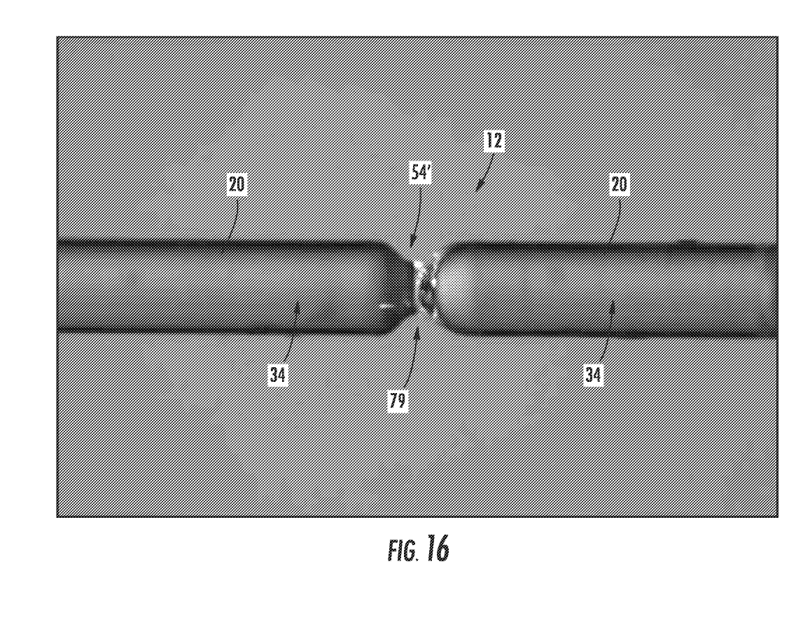

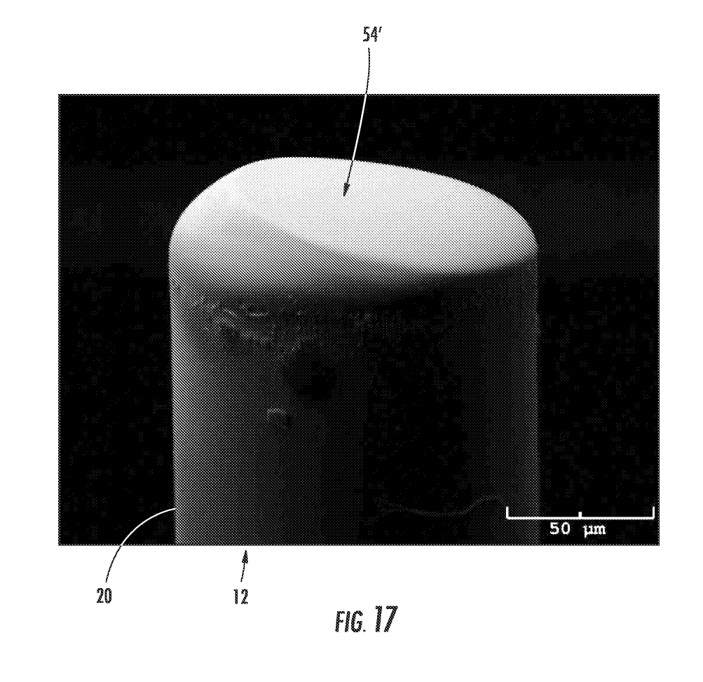

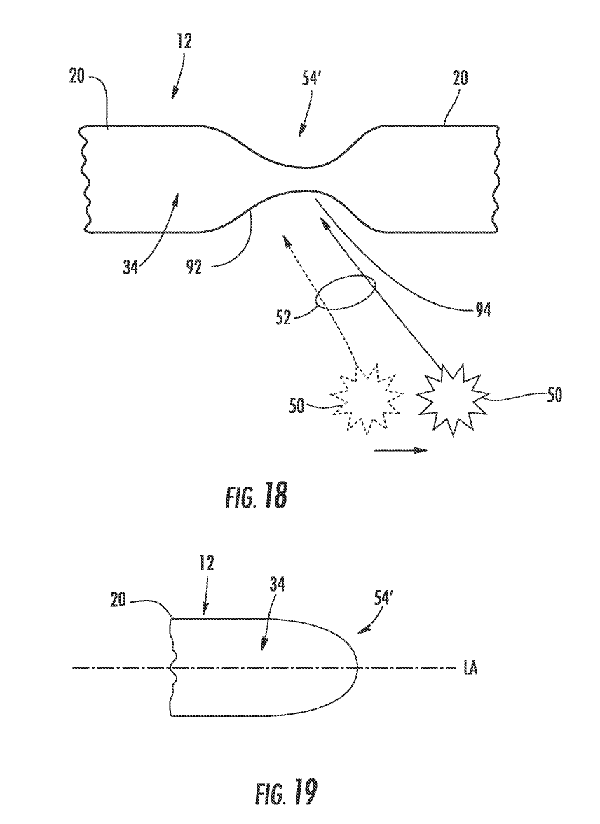

FIG. 16 is an image of an end portion 20 of the optical fiber 12 being laser-shaped as described herein before the non-planar portion is formed on the end face 54. In other words, the end portion is not completely cut through. As shown, the laser-shaping has formed a tapered (i.e., “necked”) region 79 where the laser 50 profile ablates a portion of the end portion 20. The laser 50 ablates the outer annular portion of the end portion 20, thereby forming the “necked” or hour glass region 79. The “necked” or hour glass region 79 is formed because the laser 50 has a finite beam width that has a pseudo-Gaussian intensity profile (i.e., the intensity is greater near the center and rolls off toward the edges of the laser beam 52 as depicted in FIG. 8), thereby ablating the end portion 20 the most near the center of the laser beam 52.

FIG. 17 is an image of a laser-shaped optical fiber end face 54 taken under magnification of about six-hundred times magnification (i.e., 600×). As shown, the end portion 20 has non-planar, rounded edges and a tapered and non-planar end face 54. This end portion 20 was laser-shaped using a sixty (60) watt CO₂ laser and rotating the end portion 20 at about two (2) Hz. The frequency of the individual sine wave was about forty (40) Hz, while the intermitting burst frequency was about six (6) Hz. The laser 50 (FIG. 7) was operated at a thirty (30) percent duty cycle. The rotational step took about one and one-half (1.5) seconds and the stationary step took about one (1) second. Of course, other suitable results are possible using many other parameters such as rotation speed, frequencies, power levels, incident angles, etc.

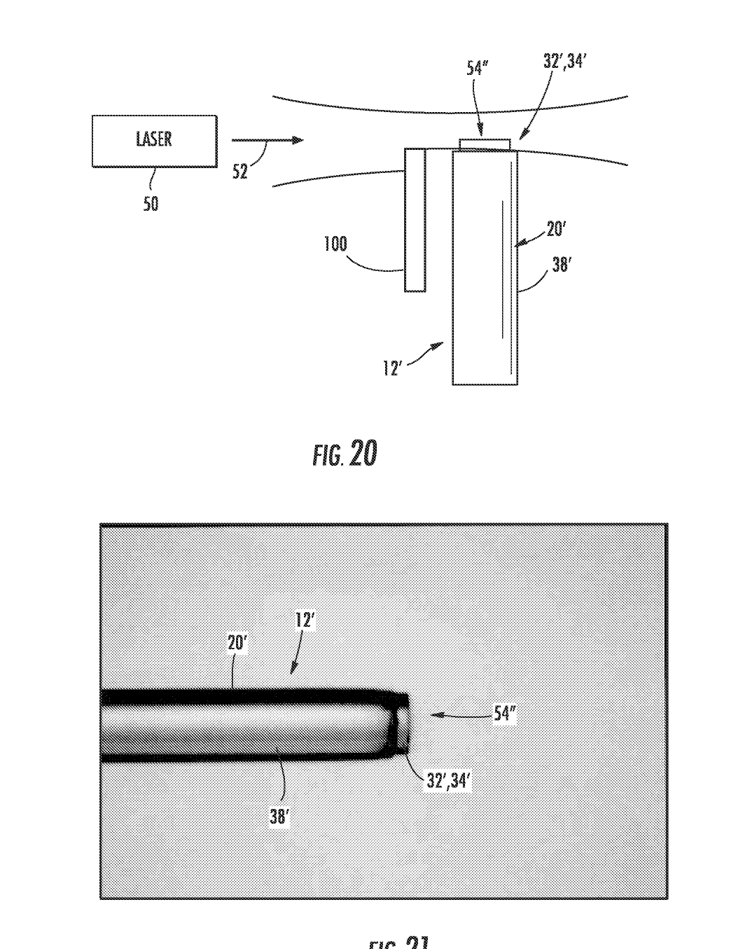

Other methods of laser-shaping the end face 54 of the end portion 20 are also possible. For instance, FIGS. 18 and 19, respectively, depict an alternative non-planar end face 54′ of the end portion 20 of the optical fiber 12 being formed with a “pencil-tip” end face 54′ and the finished end portion 20 of the optical fiber 12. “Pencil-tip” means that the end face 54′ has a relatively longer tapered portion that leads to the end face 54′ having the core 34. The pencil-tip end face 54′ can have a non-planar end face, as discussed above. The method of forming the pencil tip end face 54′ is similar to the first step of the process described herein, but further involves the step of shifting the laser beam 52 of the laser 50 or shifting the end portion 20 so that the sweeping of the laser beam 52 occurs at a second location 94. In other words, the first step is performed at a first location 92 of the end portion 20 while rotating the end portion 20 to form a “necked” region, as shown in FIG. 18. Then shifting (i.e., moving the laser beam 52 and/or the end portion 20) the ablation toward the portion of the end portion 20 that will be cut through to create a longer tapered end face 54′ (i.e., the pencil-tip shape).

FIG. 18 depicts the shifting from the first location 92 to the second location 94, as represented by the arrow. For instance, the shifting may be a suitable distance such as between two (2) μm and three hundred (300) μm, but any suitable distance is possible. Thereafter, the laser beam 52 of the laser 50 is swept through the end portion 20 to cut the same. Sweeping the laser beam 52 of the laser 50 through the end portion 20 while it is rotating at the second location 94 forms the end face 54′, as shown in FIG. 19. In other words, the pencil-tip end face 54′ has an angle of about zero degrees with a plane perpendicular to the longitudinal axis of the end portion 20. Alternatively, a non-planar end face 54′ (e.g., an angle between zero (0) and twelve (12) degrees) can be formed on the end portion 20 by sweeping the laser beam 52 of the laser 50 through the optical fiber 12 when it is essentially stopped as described above.

In an alternative embodiment, another exemplary method for processing an alternative end face 54′ of the end portion 20 comprises fixing the position of the laser beam 52 (i.e., no sweeping motion) and rotating the end portion 20. The laser 50 may be pulsed at a frequency from about eight (8) Hz to about twelve (12) Hz with a short pulse width in the micro-second range. The desired angle 82 between the beam of the laser and the optical fiber 12 may be within the ranges described previously. An important parameter in this embodiment is the location of the end portion 20 relative to the focal point of the laser beam 52. The positional relationship should be both accurate and repeatable. Although this process may produce similar results to the process described previously, automating the process is somewhat more difficult.

In another exemplary embodiment, the end portion 20 may be fixed in position (i.e., not rotated), and the laser beam 52 may be swept across the end portion 20 in the manner previously described. The laser 50 may be run in a continuous mode and the sweeping parameters of the laser beam 52 may also be the same as previously described. In one example, the laser 50 may be placed up to about a meter or more from the end portion 20 to allow the laser beam 52 to become more organized and the laser beam 52 geometry more predictable. The accuracy and repeatability of the angle 82 of the laser beam 52 with respect to the longitudinal axis of the end portion 20 is important in achieving an acceptable result. The angle 82 may depend on the characteristics of the laser beam 52, including its cross-sectional energy profile. A conventional galvanometer and external drive may be used to sweep the laser beam 52 while holding the end portion 20 stationary. Galvanometers are typically used in laser marking heads for sweeping the laser beam 52 in two (2) dimensions. The galvanometer (not shown) may be placed into the setup in conjunction with an infrared (IR) scanning (F-theta) lens (not shown) to sweep the laser beam 52 in the horizontal direction. A stepper motor (not shown) may still be used for positioning, without rotating, the fixture 40 and the end portion 20. This stationary end portion 20 and laser beam 52 sweep approach may also permit angles to be formed on the end faces 54, 54′ of the end portion 20. Ribbon fibers may also benefit from this setup and laser processing. Note that alternatively, the laser 50 could also be held stationary for any of the above referenced embodiments and the laser beam 52 pulsed to provide and shape the end faces 54, 54′.

FIGS. 20 and 21 illustrate another alternative method and apparatus for laser processing of alternative end portions 20′ of an optical fiber 12′ that includes a polymer cladding 32′ surrounding a glass core 34′ (e.g., a plastic clad silica) as opposed to a glass cladding 32 provided in the optical fiber 12, as previously discussed above. For example, the core 34′ could be one hundred (100) μm in diameter, and the polymer cladding 32′ could be one hundred twenty-five (125) μm in diameter. The laser processing includes cutting and preparing a non-planar end faces 54″ on the end portion 20′. It is sometimes desirable to minimize the length (such as to twenty-five (25) μm or less, for example) by which the polymer cladding 32′ is shrunk back when preparing the end face 54″ in order to maintain the smallest possible insertion angle of the end portion 20 into a blind hole 15 (see FIG. 8) given that some clearance is necessary between the outer diameter of the polymer cladding 32′ and inner diameter of the blind hole 15 which would permit ‘cocking’ upon insertion of the end portion 20′ into the blind hole 15. It may also be desirable to provide a longer annular space at the bottom surface 26 of the blind hole 15 so as to provide a reservoir for excess glue or index matching material, as examples, upon insertion in the region surrounding the glass core 34′ by increasing the length by which the cladding 32′ is shrunk back. So it is useful to be able to tune this length. Shielding laser energy from the laser beam 52 directed to the end portion 20′ of the optical fiber 12′ is one approach.

In this regard in this embodiment as illustrated in FIG. 20, a shield 100 is provided in the a portion of the path of the laser beam 52, because a laser beam 52 can shrink back the polymer cladding 32′ on the end portion 20 farther back from the end face 54″ than desired due to the difference in ablation rates and thermal mass between the glass core 34′ and the polymer cladding 32′. The shield 100 masks a portion of the laser beam 52 being directed towards the end face 54″ as illustrated in FIG. 20. In other words, the shield 100 reduces the amount of energy from the laser beam 52 that strikes the polymer cladding 34′ thereby controlling the shrink back of the polymer cladding 32′. The shield 100 could be made out of graphite, carbon, ceramic, or any other material that can withstand the intensity of the laser beam 52. FIG. 21 illustrates the end portion 20′ after being laser processed by the laser 50 in the configuration illustrated in FIG. 20. The other laser processing steps and laser configurations, including providing for a stationary or rotating end portion during laser processing and/or when the fixture 40 securing the end portion is kept stationary or flipped or rotated during laser processing previously discussed above can be employed in this embodiment.

Another technique to minimize the length by which the polymer cladding 32′ is shrunk back when preparing the end face 54″ could be to move the end portion 20′ slightly away (one (1) to three (3) optical fiber diameters, for example) from the focal plane of the laser beam 52 to provide a larger, though controlled spot of energy to provide the shrinking or ablation of the polymer cladding 32′. The ablation length of the polymer cladding 32′ could be made longer by increasing the number of passes with the laser 50 in which the end portion 20′ received the laser beam 52 during the cleaving operation.

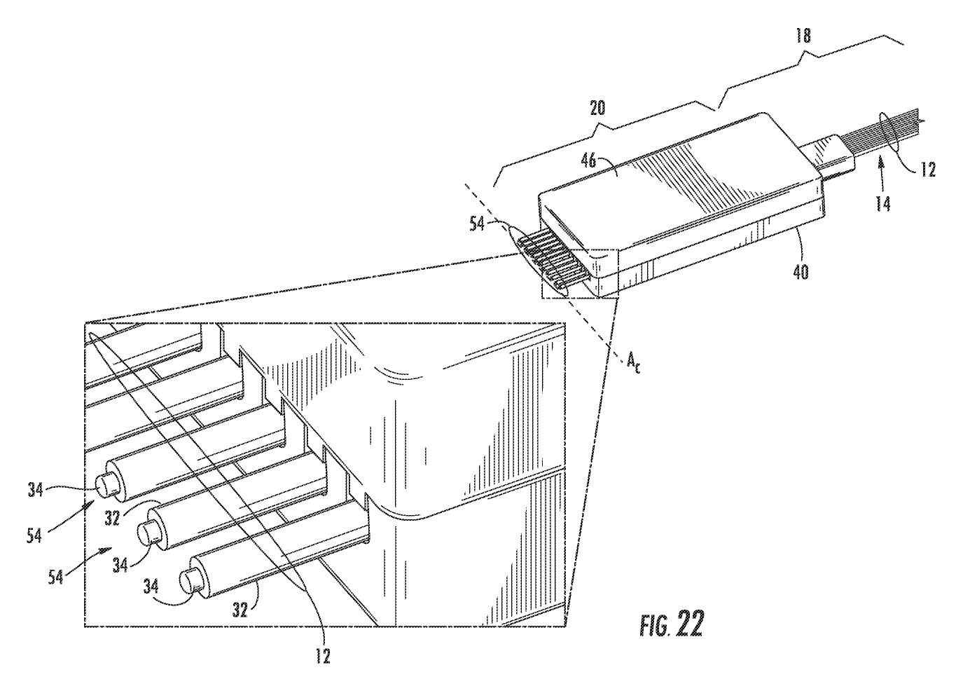

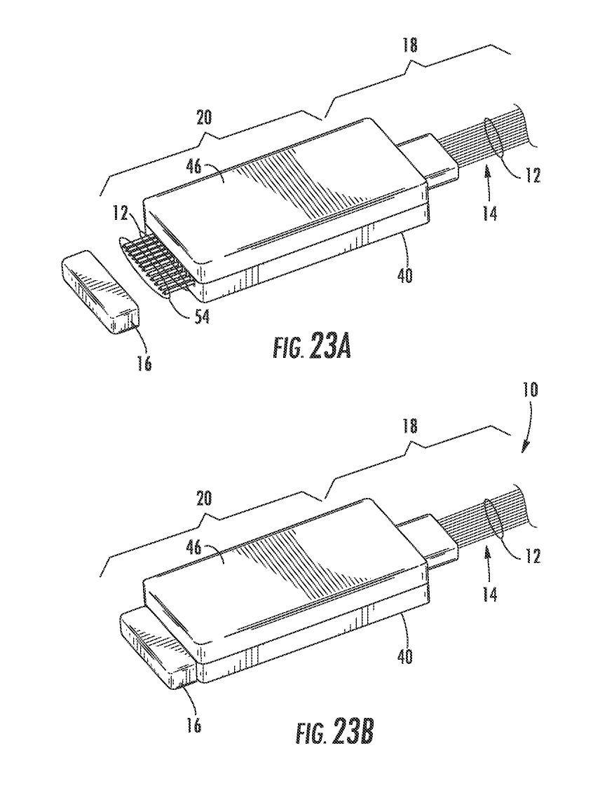

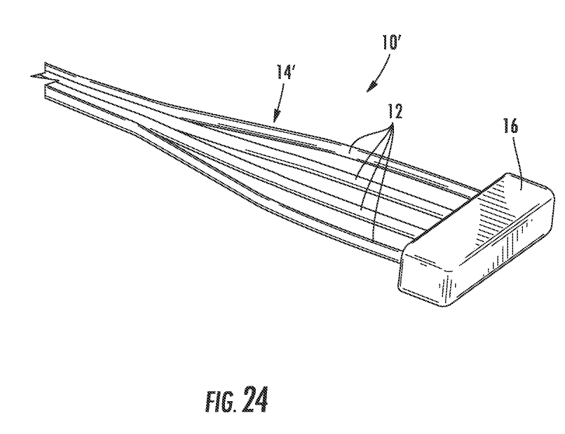

FIG. 22 illustrates an example of the end portions 20 of the optical fibers 12 extending from the fixture 40 after the end portions 20 have been laser processed by the laser 50 to provide non-planar end faces 54, according to any of the embodiments described above have been provided. At this point, the end faces 54 are co-planar and disposed in the axis Ac, as illustrated in FIG. 22. For example, each of the end faces 54 may be disposed in an axis or plane to each be within no more than 300 μm from each other and/or relative to the axis Ac. Further, for convenience purposes, only end portion 20 of the optical fiber 12 is illustrated in FIG. 22, but it is understood that the end portion 20 could be any alternative optical fiber including end portion 20′ and optical fiber 12′, and the end face 54 could be of any non-planar profile including the profiles of the end faces 54′ or 54″ prepared using the laser processing techniques described above.

At this point, the end portions 20 have been processed and are ready to be disposed in the blind holes 15 of the holding structure 16. In this regard, FIG. 23A shows the holding structure 16 aligned with the end portions 20 and their end faces 54 prior to disposition into the blind holes 15 of the holding structure 16. FIG. 23B shows the end portions 20 and their end faces 54 disposed in the blind holes 15 of the holding structure 16. The holding structure 16 may be secured to the end portions 20 using any type of holding material, including an adhesive or an epoxy, which may or may not have to be cured. The adhesive or epoxy could be disposed in and/or on the outside of and adjacent to the blind holes 15 of the holding structure 16 prior to insertion of the end portions 20 into the blind holes 15. Curing may involve ultraviolet (UV) or other radiation, including without limitation, other conductive or convective methods of heat application. In addition, an index matching material, such as an index matching gel, may be disposed at the seat 26 of the blind hole 15 on the end face 54 prior to disposition of the end portions 20 in the blind hole 15. At this point, the assembly 10 is completed and will appear substantially as shown in FIG. 1 once the fixture 40 is removed from the optical fibers 12, if desired. As will be discussed in more detail below, the fixture 40 can be removed from the optical fibers 12 in the assembly 10 or be retained with the assembly 10.

FIG. 24 illustrates an alternate assembly 10′ to the assembly 10 in FIG. 1 that could also be prepared using the fixture 40 and the methods and steps discussed above. In this embodiment, instead of a twelve (12) fiber, optical fiber array 14, as illustrated in FIG. 1, a four (4) fiber optical fiber array 14′ is provided. The optical fibers 12 provided in the optical fiber array 14′ can be any of the optical fibers previously described above and can be prepared in the same manners as previously described above. Any number of optical fibers 12 could be provided and processed according to the embodiments, included herein, including only a single optical fiber.

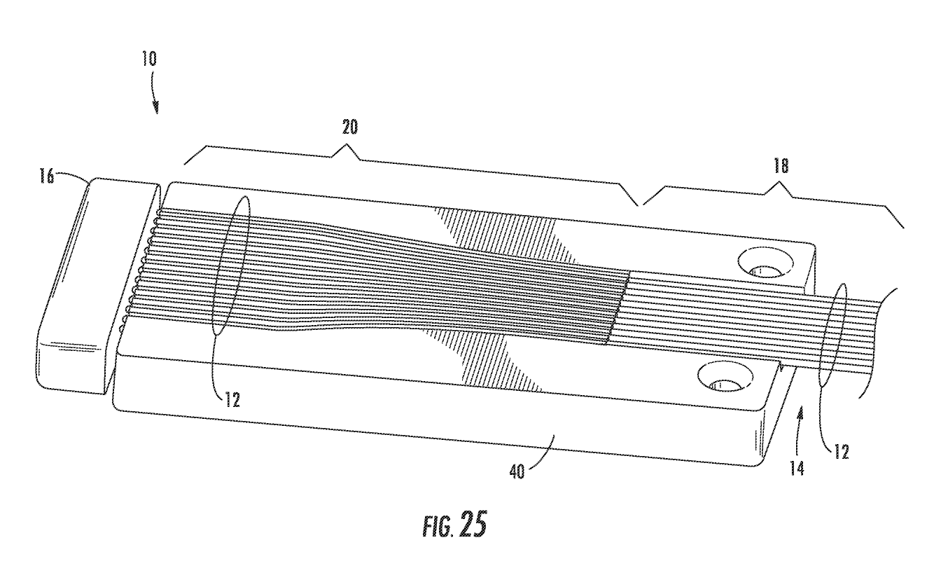

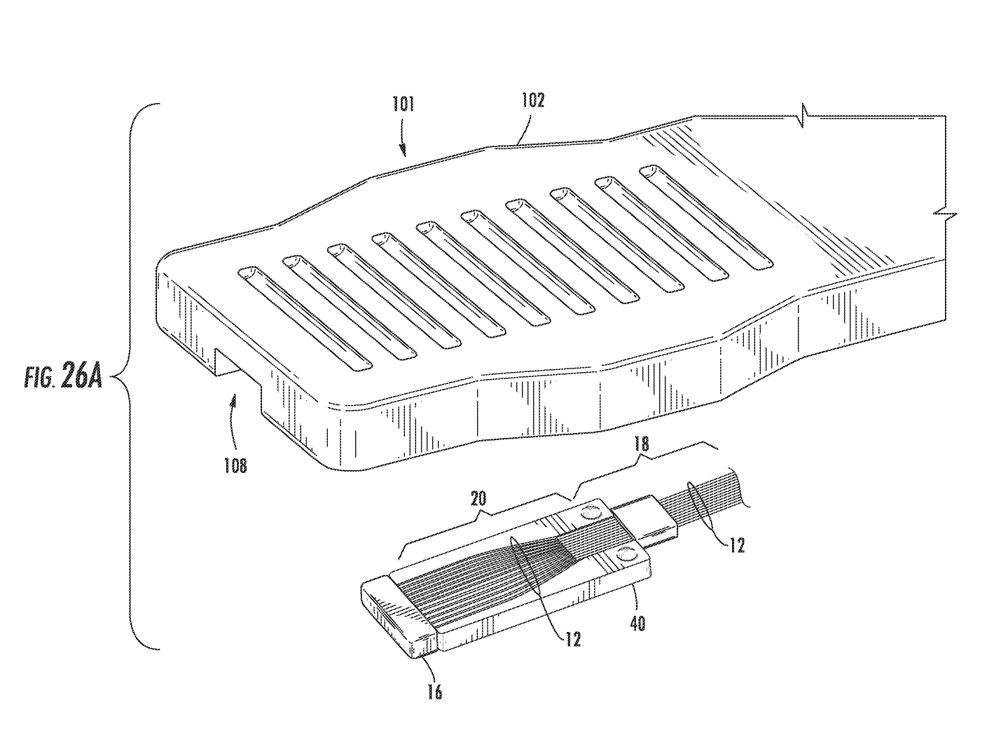

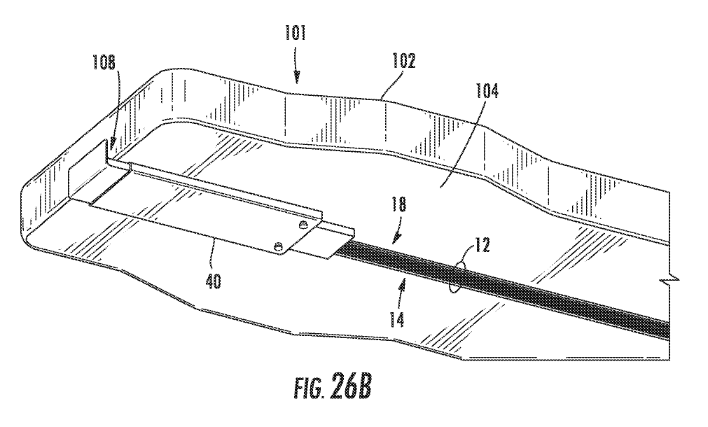

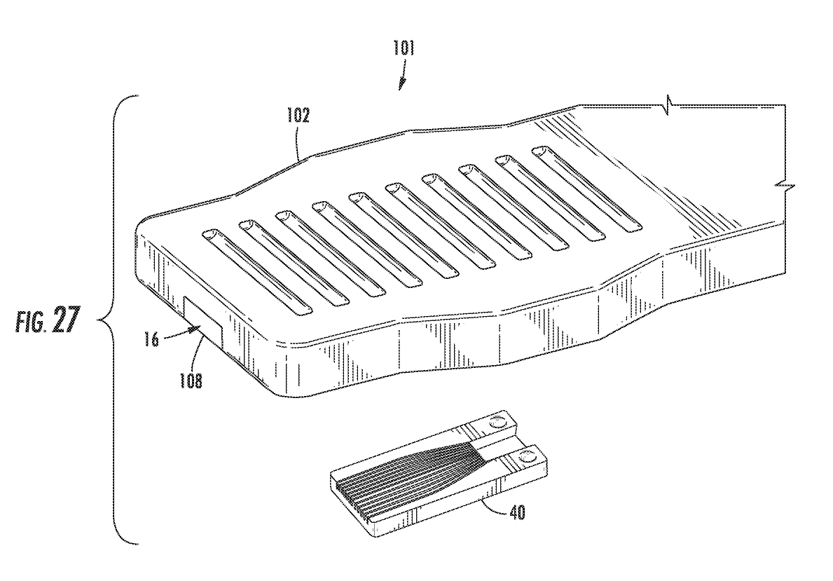

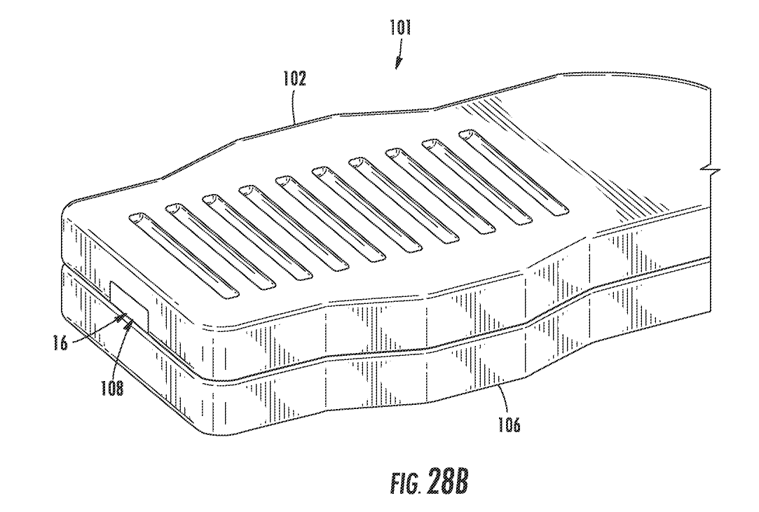

As discussed above, it may be desired to remove the fixture 40 from the assembly 10. The fixture 40 may be reused to prepare other optical fiber arrays 14, for example. In this regard, FIG. 25 illustrates the assembly 10 with its optical fibers 12 disposed in the fixture 40 as previously described, but with the cover 46 (see FIGS. 5A and 5B) of the fixture 40 removed. The fixture 40 holding the assembly 10 could be disposed in a fiber optic housing 101, as illustrated in FIG. 26A. The fiber optic housing 101 may be a fiber optic connector or adapter housing, as an example. The fiber optic housing 101 can provide a support structure to hold and secure the assembly 10 with or without the fixture 40, as will be described in more detail below. In this regard, FIG. 26B illustrates the assembly 10 disposed on a bottom surface 104 of a top portion 102 of the fiber optic housing 101. The bottom surface 104 could include a register or protrusion (not shown) that allows the fixture 40 to be used as a registering device in the bottom surface 104 of the top portion 102. In this embodiment, the top portion 102 of a fiber optic housing 101 that will eventually be secured to a bottom portion 106, as illustrated in FIG. 28A. The top portion 102 may contain a slot 108 that is configured to receive the holding structure 16, as illustrated in FIG. 26B, to secure the holding structure 16 and thus the end faces 54 (not shown) of the end portions 20 of the optical fibers 12 disposed in the blind holes 15 in a desired location relative to the fiber optic housing 101.

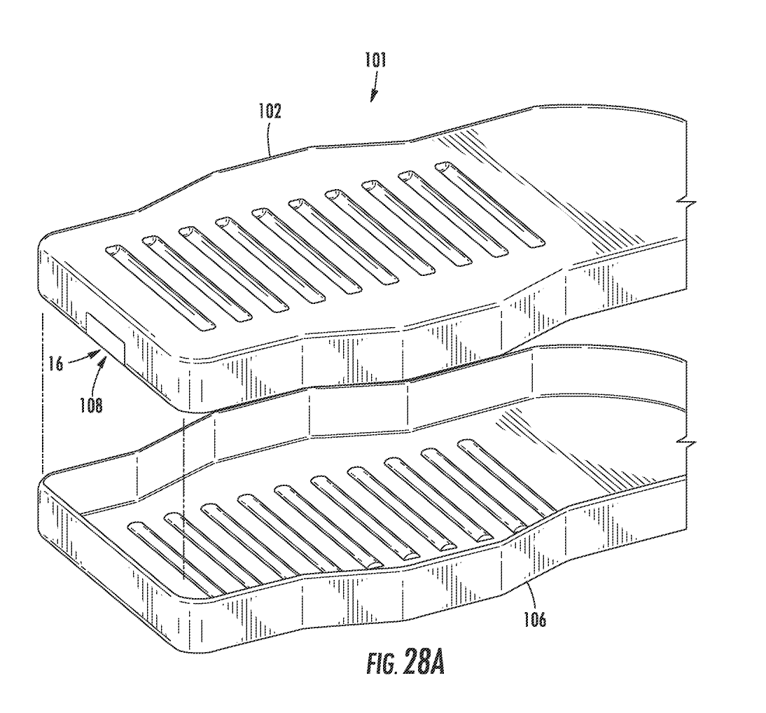

After the assembly 10 is disposed in the top portion 102 of the fiber optic housing 101, the fixture 40 may be removed from the assembly 10, as illustrated in FIG. 27. The fixture 40 may be removed by ejecting the optical fibers 12 from the channels 42 (see FIG. 4) in the fixture 40. As this point, the holding structure 16 of the assembly 10 is disposed in the slot 108 of the fiber optic housing 101, as illustrated in FIG. 28A. The bottom portion 106 of the fiber optic housing 101 may then be secured to the top portion 102 of the fiber optic housing 101 to secure the holding structure 16 and assembly 10 inside the fiber optic housing 101, as illustrated in FIG. 28B. The fiber optic housing 101 can then be connected or disposed according to any application desired to place the holding structure 16 and the end faces 54 of the end portions 20 of the optical fibers (e.g., as shown in FIG. 22) in the desired location. Alternatively, the fixture 40 could be retained in the fiber optic housing 101 to retain the holding structure 16 and optical fiber array 14 in the fiber optic housing 101, if desired.

Many modifications and other embodiments will come to mind to one skilled in the art to which the invention pertains having the benefit of the teachings presented in the foregoing descriptions and the associated drawings. These modifications include, but are not limited to, the number of optical fibers, the type of optical fibers, the type of optical fiber assembly, fixture, number of channels in the fixture, type of cutting of the end portions, laser processing, and shape of the end faces of the end portions. The fiber optic array disposed in the holding structure may be disposed in a fiber optic housing, including but not limited to a fiber optic connector and fiber optic connector. The fixture may or may not be retained in a fiber optic housing.

Further, as used herein, it is intended that the terms “fiber optic cables” and/or “optical fibers” include all types of single mode and multi-mode light waveguides, including one or more optical fibers that may be upcoated, colored, buffered, ribbonized and/or have other organizing or protective structure in a cable such as one or more tubes, strength members, jackets or the like. Likewise, other types of suitable optical fibers include bend-insensitive optical fibers, or any other expedient of a medium for transmitting light signals. An example of a bend-insensitive optical fiber is ClearCurve® fiber commercially available from Corning Incorporated.

Although the disclosure has been illustrated and described herein with reference to certain embodiments and specific examples thereof, it will be readily apparent to those of ordinary skill in the art that other embodiments and examples can perform similar functions and/or achieve like results. It is to be understood that the disclosure is not to be limited to the specific embodiments disclosed and that modifications and other embodiments are intended to be included within the scope of the appended claims. It is intended that the present disclosure cover the modifications and variations provided they come within the scope of the appended claims and their equivalents. All such equivalent embodiments and examples are within the spirit and scope of the disclosure and are intended to be covered by the appended claims. Thus, it is intended that the present disclosure cover the modifications and variations disclosed herein provided they come within the scope of the appended claims and their equivalents. Although specific terms are employed herein, they are used in a generic and descriptive sense only and not for purposes of limitation.

We claim:

1. A method for processing an optical fiber, comprising:
processing an end portion of at least one optical fiber with a laser to form a non-planar end face on the end portion;
disposing the end portion of the at least one optical fiber into a blind hole disposed in a holding structure; and
attaching the at least one optical fiber to the holding structure.

2. The method of claim 1, wherein the at least one optical fiber is comprised of a plurality of optical fibers provided in an optical fiber array.

3. The method of claim 1, wherein disposing the end portion comprises bottoming the non-planar end face of the at least one optical fiber in a non-planar seat disposed in the blind hole.

4. The method of claim 1, further comprising mechanically cleaving the end portion of the at least one optical fiber prior to processing the end portion with the laser.

5. The method of claim 1, wherein processing the end portion of the at least one optical fiber further comprises drawing back a polymer cladding of the at least one optical fiber.

6. The method of claim 1, wherein the at least one optical fiber is comprised of a core surrounded by either a glass cladding or a polymer cladding.

7. The method of claim 1, further comprising rotating the at least one optical fiber during the processing of the end portion of the at least one optical fiber with the laser.

8. The method of claim 1, further comprising removing a coating from at least a portion of the at least one optical fiber.

9. The method of claim 1, wherein the processing further comprises processing the end portion with a laser to provide a non-planar profile on an outer coating of the at least one optical fiber to prevent stubbing or skiving of the at least one optical fiber when disposed in the blind hole.

10. The method of claim 1, further comprising disposing the at least one optical fiber attached to the holding structure in a fiber optic housing to form at least a portion of a fiber optic connector.

11. The method of claim 1, further comprising placing the at least one optical fiber in at least one channel of a fixture.

12. The method of claim 11, further comprising displacing the at least one optical fiber from the at least one channel of the fixture.

13. The method of claim 11, further comprising disposing the fixture in a fiber optic housing while the at least one optical fiber is retained in the at least one channel of the fixture to form at least a portion of a fiber optic connector.

14. An assembly according to the method of claim 1.

15. A method for processing an optical fiber array, comprising:
providing a fixture;
placing a plurality of optical fibers into a plurality of channels disposed in the fixture;
processing end portions of each of the plurality of the optical fibers with a laser to form non-planar end faces on each of the end portions;
disposing each of the end portions of the plurality of optical fibers into respective blind holes disposed in a holding structure; and
attaching the plurality of optical fibers to the holding structure.

16. The method of claim 15, wherein the plurality of optical fibers have a co-planarity of 300 micrometers or less after the processing of the end portions with the laser.

17. The method of claim 15, further comprising disposing a cover on the fixture after disposing each of the end portions of the plurality of optical fibers into the respective blind holes disposed in the holding structure.

18. The method of claim 15, wherein disposing each of the end portions comprises bottoming non-planar end faces on each of the plurality of optical fibers in respective non-planar seats disposed in each of the respective blind holes.

19. The method of claim 15, further comprising flipping the fixture during the processing of the end portions of each of the plurality of optical fibers with the laser.

20. The method of claim 15, further comprising displacing the plurality of optical fibers from the fixture prior to or after attaching the plurality of optical fibers to the holding structure.

21. The method of claim 15, further comprising disposing the plurality of optical fibers attached to the holding structure in a fiber optic housing to form at least a portion of a fiber optic connector.

22. The method of claim 15, further comprising disposing the fixture in a fiber optic housing while the plurality of optical fibers are retained in the plurality of channels disposed in the fixture to form at least a portion of a fiber optic connector.

23. The method of claim 15, wherein the processing further comprises processing the end portions with a laser to provide non-planar profiles on outer coatings of the plurality of optical fibers to prevent stubbing or skiving of the plurality of optical fibers when disposed in the blind hole.

24. An assembly according to the method of claim 15.

25. A holding structure assembly for an array of optical fibers, comprising:
a plurality of optical fibers; and
a holding structure comprised of a plurality of blind holes with end portions of the plurality of optical fibers processed with a laser disposed therein to form non-planar end faces on the end portions.

26. The holding structure assembly of claim 25, wherein the non-planar end faces are bottomed in respective non-planar seats disposed in each of the plurality of blind holes.

27. The holding structure assembly of claim 25 disposed in a fiber optic housing to provide at least a portion of a fiber optic connector.

28. The holding structure assembly of claim 25, further comprising a fixture comprised of a plurality of channels each retaining an optical fiber among the plurality of optical fibers.

29. The holding structure assembly of claim 28, wherein the fixture is disposed in a fiber optic housing to provide at least a portion of a fiber optic connector.

30. The holding structure assembly of claim 28, further comprising a cover disposed on the fixture.
